(19) United States
(12) Patent Application Publication
(10) Pub. No.: US 2024/0181815 A1
(43) Pub. Date: Jun. 6, 2024

(54) PNEUMATIC TIRE FOR HEAVY LOAD

(71) Applicant: Toyo Tire Corporation, Itami-shi (JP)

(72) Inventor: Harunobu Suita, Itami-shi (JP)

(73) Assignee: Toyo Tire Corporation, Itami-shi (JP)

(21) Appl. No.: 18/389,281

(22) Filed: Nov. 14, 2023

(30) Foreign Application Priority Data
Dec. 1, 2022 (JP) 2022-192812

(51) Int. Cl. B60C 11/13

(52) U.S. Cl. CPC B60C 11/13; B60C 2011/0353

(57) ABSTRACT

In a pneumatic tire for heavy load according to the embodiment, a shoulder rib provided on a tread surface includes a thin groove extending in a tire circumferential direction on an inner side in a tire axial direction of a ground contact end, a main body rib formed on the inner side in the tire axial direction of the thin groove, a sacrifice rib formed on an outer side in the tire axial direction of the thin groove, and sipes provided in the main body rib and opening to the thin groove, and a depth Dg of the thin groove, a depth Dm of a shoulder main groove, and a depth Ds of the sipe satisfy 1.10≤Dg/Dm≤ 1.20 and 0.5≤Ds/Dg≤0.7.

### BACKGROUND OF THE INVENTION

### 1. Field of the Invention

The present invention relates to a pneumatic tire for heavy load.

### 2. Description of Related Art

In a pneumatic tire for heavy load to be mounted on a truck, a bus, or the like, a ground contact pressure normally tends to be increased near a ground contact end of a shoulder rib on a tread at the time of traveling. As a result, irregular wear may be a problem; namely, a wear amount near the ground contact end of the shoulder rib is increased as compared with wear amounts of other lands on the tread.

As a tire for suppressing such irregular wear, there is proposed a tire in which a thin groove extending along a tire circumferential direction is provided near the ground contact end of the shoulder rib to thereby partition the shoulder rib into a main body rib on an inner side in a tire axial direction and a sacrifice rib on an outer side in the tire axial direction, and sipes opening to the thin groove are provided in the main body rib (for example, refer to JP2009-90949A).

In the above tire, the ground contact pressure in the main body rib which largely contributes to substantial tire performance can be made uniform and the irregular wear can be reduced; however, when a relatively large frictional force acts on the main body rib, a crack starting from a groove bottom of the sipe may occur in the main body rib, which may partially damage the main body rib.

### SUMMARY OF THE INVENTION

The present invention has been made in view of the above circumstances, and an object thereof is to provide a pneumatic tire for heavy load capable of suppressing the damage of the main body rib partitioned by the thin groove provided near the ground contact end of the shoulder rib while suppressing the irregular wear of the shoulder rib.

A pneumatic tire for heavy load according to an embodiment is provided with a tread rubber provided on a tread, a belt layer including a plurality of belts provided on an inner side in a tire radial direction of the tread rubber, three or more main grooves provided on a tread surface of the tread rubber and extending in a tire circumferential direction, and a plurality of ribs formed by the main grooves on the tread surface, in which the three or more main grooves include a shoulder main groove provided on an outer side in a tire axial direction, the plurality of ribs include a shoulder rib formed on the outer side in the tire axial direction of the shoulder main groove, the shoulder rib includes a thin groove extending in the tire circumferential direction on an inner side in the tire axial direction of a ground contact end, a main body rib formed on the inner side in the tire axial direction of the thin groove, a sacrifice rib formed on the outer side in the tire axial direction of the thin groove, and sipes provided in the main body rib and opening to the thin groove, and a depth Dg of the thin groove, a depth Dm of the shoulder main groove, and a depth Ds of the sipe satisfy the following formulas (1) and (2).

1.10≤Dg/Dm≤1.20 formula (1)

0.5≤Ds/Dg≤0.7 formula (2)

The above pneumatic tire for heavy load is capable of suppressing occurrence of a crack starting from the groove bottom of the thin groove to thereby suppress the damage of the sacrifice rib while suppressing the irregular wear of the shoulder rib.

### BRIEF DESCRIPTION OF THE DRAWINGS

FIG. 1 is a half cross sectional view of a pneumatic tire for heavy load according to a first embodiment of the present invention;

FIG. 2 is a main part enlarged view of FIG. 1; and

FIG. 3 is a developed view showing a tread pattern of the pneumatic tire for heavy load shown in FIG. 1.

### DESCRIPTION OF EMBODIMENTS

Hereinafter, a pneumatic tire for heavy load (hereinafter may be referred to as a pneumatic tire) according to an embodiment of the present invention will be explained with reference to the drawings.

Respective dimensions in the specification are in a normal state at no load in which the pneumatic tire is fitted to a normal rim and a normal internal pressure is filled unless specifically mentioned otherwise. In the specification, a ground contact state indicates a state in which a pneumatic tire 10 is placed vertically on a flat road surface and a normal load is added while the tire is assembled to the normal rim and the normal internal pressure is filled. Moreover, a ground contact end E indicates an end in a tire axial direction of a tread surface which contacts the road surface in the ground contact state.

The normal rim is a rim specified by a standard for each tire in a standard system including the standard with which the tire complies, which includes, for example, a standard rim in JATMA and “measuring Rim” in TRA and ETRTO. The normal internal pressure is an air pressure specified by each standard for each tire in the standard system including the standard with which the tire complies, which includes the maximum air pressure in JATMA, the maximum value described in the table “TIRE LOAD LIMITS AT VARIOUS COLD INFLATION PRESSURES” in TRA, and “INFLATION PRESSURE” in ETRTO in the case of tires for trucks and busses or tires for light trucks.

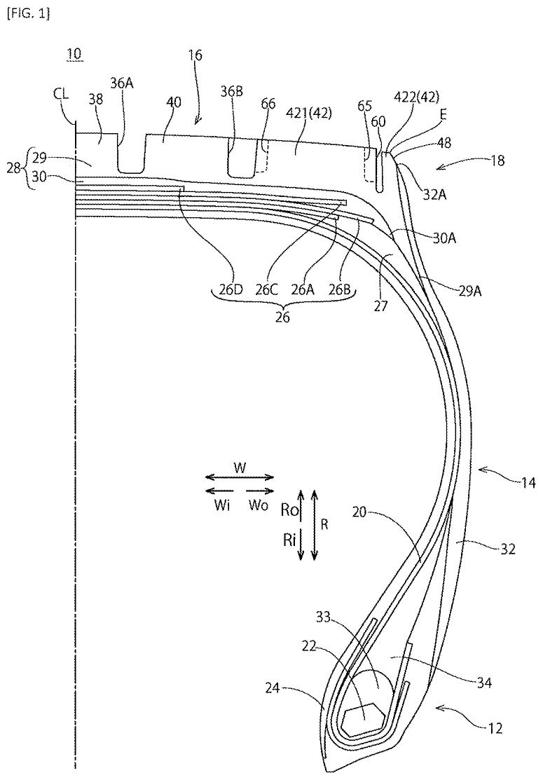

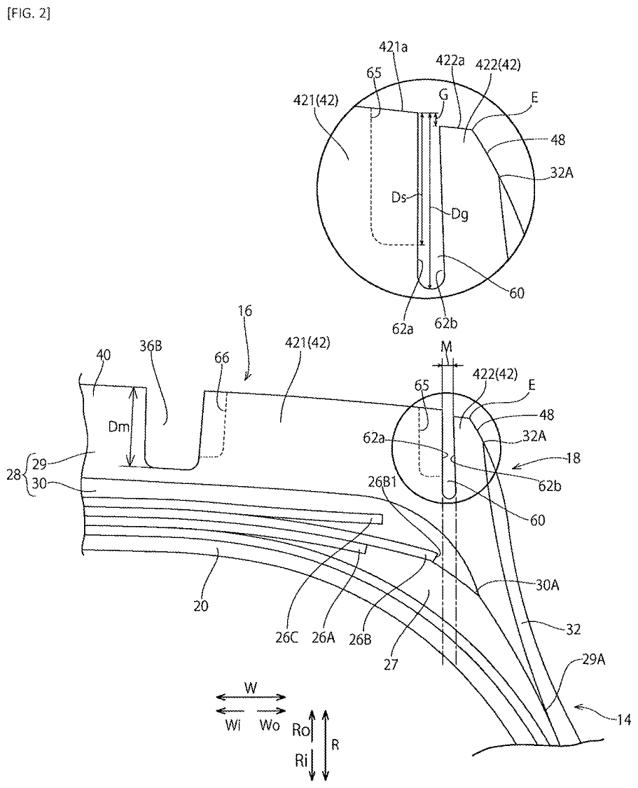

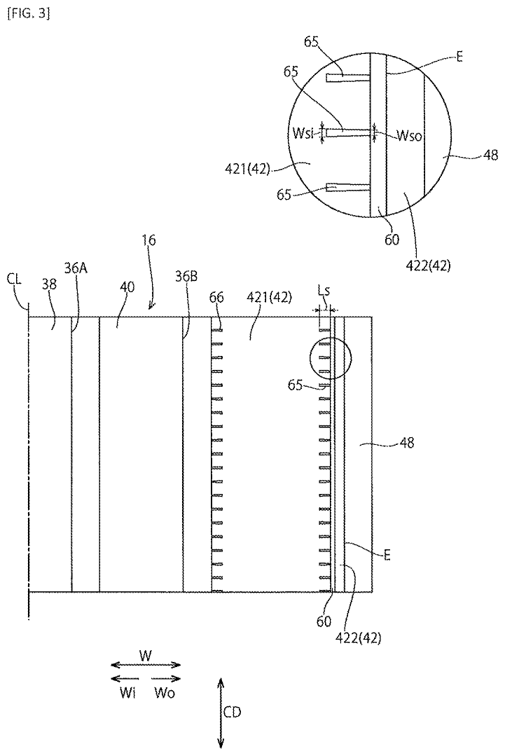

Moreover, a symbol CL in the drawing denotes a tire equatorial plane corresponding to the center in the tire axial direction. A symbol W denotes the tire axial direction (also referred to as a tire width direction), an inner side Wi in the tire axial direction indicates a direction getting closer to the tire equatorial plane CL, and an outer side Wo in the tire axial direction indicates a direction away from the tire equatorial plane CL. A symbol CD denotes a tire circumferential direction which is a direction on a circumference centered at a tire rotation axis. A symbol R denotes a tire radial direction (direction orthogonal to the tire rotation axis). FIG. 1 is a right side half cross sectional view obtained by cutting the pneumatic tire 10 according to the embodiment on a meridian section including a tire axis. FIG. 2 is a main part enlarged view of FIG. 1, and FIG. 3 is a developed view showing a tread pattern. Since the pneumatic tire 10 is a right and left symmetric tire, a left side half is not shown in FIG. 1 and FIG. 3.

The pneumatic tire 10 of FIG. 1 includes a right and left pair of beads 12, a right and left pair of sidewalls 14 extending outward in the radial direction from the beads 12, a tread 16 forming the tread surface, and a right and left pair of buttresses 18 arranged on an inner side in the tire radial direction of the tread 16. Here, the buttress 18 corresponds to a boundary region between the tread 16 and the sidewall 14, which is provided so as to connect between the tread 16 and the sidewall 14.

The pneumatic tire 10 has a carcass ply 20 provided to be hung across the pair of beads 12 in a toroidal shape. Ring shaped bead cores 22 are respectively buried in the pair of beads 12.

The carcass ply 20 extends from the tread 16 through the buttresses 18 and the sidewalls 14, and is locked by the bead cores 22 at the beads 12. The carcass ply 20 reinforces the beads 12, the sidewalls 14, the buttresses 18, and the tread 16. In this example, the carcass ply 20 is locked by turning up both ends thereof from the inside to the outside in the tire axial direction around the bead cores 22. An inner liner 24 for holding an air pressure is arranged on the inner side of the carcass ply 20.

The carcass ply 20 is composed of at least a piece of ply formed by arranging reinforcing cords such as steel cords at a predetermined angle (for example, 70° to 90°) with respect to the tire circumferential direction CD and covering the reinforcing cords with topping rubber, which is composed of one ply in this example.

In the bead 12, bead fillers 33, 34 made of a hard rubber material extending toward an outer side Ro in the tire radial direction in a tapered shape are arranged on an outer circumferential side of the bead core 22. The bead fillers 33, 34 are made of two kinds of rubbers in the drawing; however, the bead fillers 33, 34 may be made of one kind of rubber.

The sidewall 14 is provided with a sidewall rubber 32 on an outer side of the carcass ply 20 (namely, an outer surface side of the tire). The sidewall rubber 32 is provided so as to extend from the vicinity of the bead 12 toward the outer side Ro in the tire radial direction and extend across the bead 12 and a tread rubber 28. An outer end 32A in the tire radial direction of the sidewall rubber 32 is arranged on a tire outer surface so as to overlap with a base rubber layer 30 which forms an outer side in the tire axial direction of the tread rubber 28.

In the tread 16, a belt 26 is provided on an outer circumferential side of the carcass ply 20, and the tread rubber 28 is provided on an outer circumferential side of the belt 26. That is, the belt 26 is provided between the carcass ply 20 and the tread rubber 28 in the tread 16.

The belt 26 is composed of a plurality of cross belt plies formed by arranging belt cords at a predetermined angle (for example, 10° to 60°) with respect to CD. Steel cords or organic fiber cords having high tensile strength are used for the belt cords.

The belt 26 has a four layer structure including a first belt 26A placed on the innermost of an inner side Ri in the tire radial direction, a second belt 26B, a third belt 26C, and a fourth belt 26D sequentially layered on an outer circumferential side of the first belt 26A in this example. The second belt 26B is the maximum width belt having the widest width in the four layered belts 26A, 26B, 26C, and 26D.

Beit carcass wedge shaped rubbers 27 having a trapezoidal shape in cross section are provided on the inner side Ri in the tire radial direction on both ends in the tire axial direction of the first belt 26A and the second belt 26B. The both ends in the tire axial direction of the first belt 26A and the second belt 26B are gradually separated from the carcass ply 20 due to the belt carcass wedge shaped rubbers 27.

The tread rubber 28 has a two layer structure including a cap rubber layer 29 having a tread surface contacting the road surface and the base rubber layer 30 arranged on the inner side Ri in the tire radial direction of the cap rubber layer 29.

The cap rubber layer 29 terminates on the inner side Ri in the tire radial direction with respect to an outer end 30A in the tire axial direction of the base rubber layer 30. That is, an outer end 29A in the tire axial direction of the cap rubber layer 29 is placed on the outer side Wo in the tire axial direction and on the inner side Ri in the tire radial direction with respect to the outer end 30A in the tire axial direction of the base rubber layer 30. Accordingly, the whole width of the base rubber layer 30 is covered with the cap rubber layer 29 and is not exposed to an outer side surface of the tire. Moreover, the outer end 30A in the tire axial direction of the base rubber layer 30 covers all outer ends in the tire axial direction of the belt 26 from the outer side Ro in the tire radial direction.

The base rubber layer 30 is made of rubber having a lower 100% modulus than rubber which makes the cap rubber layer 29 and the belt carcass wedge shaped rubbers 27. The cap rubber layer 29 is made of rubber having a lower 100% modulus than rubber which makes the belt carcass wedge shaped rubbers 27. That is, the 100% modulus of rubber to be used is increased in the order of the base rubber layer 30, the cap rubber layer 29, and the belt carcass wedge shaped rubbers 27.

For example, the 100% modulus of rubber making the base rubber layer 30 is between 80 MPa and 100 MPa, inclusive, the 100% modulus of rubber making the cap rubber layer 29 is between 100 MPa and 120 MPa, inclusive, and the 100% modulus of rubber making the belt carcass wedge shaped rubbers 27 is between 120 MPa and 130 MPa, inclusive.

Note that the 100% modulus is measured in conformity with JIS K6251: 2010 3. 7. Specifically, a value is obtained by dividing a tensile force generated when a test piece of Dumbbell No. 3 is stretched until reaching 100% under an atmosphere at 23° C. by an initial cross sectional area of the test piece.

On a surface of the tread 16 (the cap rubber layer 29), three or more (four, in the embodiment) main grooves 36A, 36A, 36B, and 36B extending along the tire circumferential direction CD are provided as shown in FIG. 3. Specifically, the main grooves 36 include a pair of center main grooves 36A arranged on both sides of the tire equatorial plane CL and a pair of shoulder main grooves 36B provided on outer sides Wo in the tire axial direction of the pair of center main grooves 36A.

A center rib 38 is formed between the two center main grooves 36A, intermediate ribs 40 are formed between the center main grooves 36A and the shoulder main grooves 36B, and shoulder ribs 42 are formed on the outer sides Wo in the tire axial direction of the two shoulder main grooves 36B on the tread 16. A groove width at open ends of respective main grooves 36A, 36A, 36B, and 36B is set to, for example, between 9 mm and 13 mm, inclusive, and a depth of respective main grooves 36A, 36A, 36B, and 36B is set to, for example, between 10.0 mm and 15.0 mm, inclusive.

Note that the plurality of main grooves 36A, 36A, 36B, and 36B may be zigzag shaped grooves extending in the tire circumferential direction CD while bending in the tire axial direction W, or may be straight grooves extending straight in the tire circumferential direction CD. Moreover, a case where the center rib 38, the intermediate ribs 40, and the shoulder ribs 42 are ribs continuously extending in the tire circumferential direction CD will be explained in the embodiment; however, the center rib 38 and the intermediate ribs 40 may be block lines divided in the tire circumferential direction CD by lateral grooves.

An outer end in the tire axial direction of a tread surface (outer surface) 42a of the shoulder rib 42 forms the ground contact end E. The buttress 18 extending inward in the tire radial direction and forming an upper part of a tire side surface is connected to the ground contact end E.

As shown in FIG. 1 and FIG. 2, an inclined surface 48 extending from the ground contact end E to the inner side Ri in the tire radial direction is formed on an outer surface of the buttress 18. The inclined surface 48 is inclined so as to be expanded to the outer side Wo in the tire axial direction as extending from the ground contact end E to the inner side Ri in the tire radial direction. A cross sectional shape of the inclined surface 48 shown in FIG. 2 has a curved shape gradually expanding to the outer side in the tire radial direction in the embodiment. Such inclined surface 48 properly reduces the rigidity of the shoulder rib 42 on the ground contact end E side and improves performance against wandering at the time of climbing over a step such as a rut on the road surface.

Then, a thin groove 60 is provided in the shoulder rib 42 on the inner side Wi in the tire axial direction of the ground contact end E along the tire circumferential direction CD. The thin groove 60 partitions the shoulder rib 42 into a main body rib 421 on the inner side Wi in the tire axial direction and a sacrifice rib 422 on the outer side Wo in the tire axial direction.

The thin groove 60 is a recessed groove recessed in the inner side RI in the tire radial direction from the tread surface 42a, extending straight along the tire circumferential direction CD. In a pair of groove walls 62a, 62b demarcating the thin groove 60 as shown in FIG. 2, the groove wall 62a on the main body rib 421 side is provided in parallel to the tire equatorial plane CL and the groove wall 62b on the sacrifice rib 422 side is inclined so that a groove width narrows toward an open end in the embodiment. It is also preferable that the pair of groove walls 62a, 62b are both provided in parallel to the tire equatorial plane CL so that the groove width of the thin groove 60 is constant in a depth direction. A groove width M at the open end of the thin groove 60 is set to, for example, between 1.5 mm and 3.0 mm, inclusive, and a depth Dg of the thin groove 60 is set to, for example, between 10.0 mm and 17.0 mm, inclusive.

The thin groove 60 is preferably provided on the outer side Wo in the tire axial direction with respect to an end 26B1 in the tire axial direction of the second belt 26B having the widest width. Moreover, the thin groove 60 is preferably provided so that the cap rubber layer 29 and the base rubber layer 30 are placed on the inner side Ri in the tire radial direction of the thin groove 60.

A tread surface 422a of the sacrifice rib 422 is placed on the inner side Ri in the tire radial direction with respect to a tread surface 421a of the main body rib 421, and a gap G is formed by the sacrifice rib 422 and the main body rib 421. The gap G is preferably provided to be smaller than a depth Ds of a later described sipe 65. For example, the gap G is set to between 0.5 mm and 1.5 mm, inclusive.

A plurality of sipes 65 are arranged in the tire circumferential direction CD at equal intervals on the outer side Wo in the tire axial direction of the main body rib 421. The sipes 65 open to the thin groove 60 and extend in the tire axial direction W toward the inside of the main body rib 421. A sipe width of the sipe 65 gradually narrows from an inner end in the tire axial direction toward an outer end in the tire axial direction (an open end that opens to the thin groove 60).

For example, the depth Ds of the sipe 65 is set to between 8.0 mm and 12.0 mm, inclusive. For example, a length Ls of the sipe 65 is set to between 3.5 mm and 4.5 mm, inclusive. It is preferable that the sipes 65 are formed in such a width that the sipes 65 are closed in the ground contact state of the tire. For example, a sipe width Wso at the outer end in the tire axial direction of the sipe 65 is set to between 0.4 mm and 0.6 mm, inclusive, and a sipe width Wsi in the inner end in the tire axial direction is set to between 0.6 mm and 0.8 mm, inclusive.

A plurality of sipes 66 are also arranged in the tire circumferential direction at equal intervals on the inner side Wi in the tire axial direction of the main body rib 421. The sipes 66 open to the shoulder main groove 36B and extend in the tire axial direction W toward the inside of the main body rib 421. In the embodiment, the sipes 66 have the same shape as the sipes 65 provided on the outer side Wo in the tire axial direction of the main body rib 421. The sipes 66 and the sipes 65 are provided at symmetrical positions about the center in the tire axial direction of the main body rib 421. Note that the sipes 66 may have a different shape from the sipes 65, and it is not always necessary that the sipes 66 and the sipes 65 are provided at symmetrical positions about the center in the tire axial direction of the main body rib 421.

In the pneumatic tire 10 having the above structure, when the depth of the thin groove 60 is Dg, the depth of the shoulder main groove 36B is Dm, and the depth of the sipe 65 provided on the outer side Wo in the tire axial direction of the main body rib 421 is Ds as shown in FIG. 2, respective dimensions are set so as to satisfy the following formulas (1) and (2).

1.10≤Dg/Dm≤1.20 formula (1)

0.5≤Ds/Dg≤0.7 formula (2)

The depth Dg of the thin groove 60 is set to 1.1 times or more of the depth Dm of the shoulder main groove 36B in the pneumatic tire 10 of the embodiment; therefore, the sacrifice rib 422 is not easily worn out, and the ground contact pressure on the outer side Wo in the tire axial direction of the main body rib 421 can be reduced for a long time, which can suppress irregular wear of the shoulder rib 42. Moreover, the depth Dg of the thin groove 60 is set to 1.2 times or less of the depth Dm of the shoulder main groove 36B; therefore, a groove bottom of the thin groove 60 is not too close to the belt 26 and a desired distance can be secured, which can suppress occurrence of a crack on the groove bottom of the thin groove 60.

The depth Ds of the sipe 65 is set to 0.5 times or more of the depth Dg of the thin groove 60 in the pneumatic tire 10 of the embodiment; therefore, the ground contact pressure on the outer side Wo in the tire axial direction of the main body rib 421 can be effectively reduced, which can suppress irregular wear of the shoulder rib 42. Furthermore, the depth Ds of the sipe 65 is set to 0.7 times or less of the depth Dg of the thin groove 60; therefore, the rigidity at portions interposed between the sipes 65 adjacent to each other in the tire circumferential direction in the main body rib 421 can be secured, which can suppress occurrence of a crack on the outer side Wo in the tire axial direction of the main body rib 421.

In the case where the pair of groove walls 62a, 62b demarcating the thin groove 60 are provided in parallel to the tire equatorial surface CL so that the groove width of the thin groove 60 is constant in the depth direction, the rigidity of the main body rib 421 can be secured and the damage of the main body rib 421 can be suppressed.

Since the thin groove 60 is provided on the outer side Wo in the tire axial direction with respect to the end 2681 in the tire axial direction of the widest second belt 268 in the embodiment, strains that intensively occur in the groove bottom of the thin groove 60 can be alleviated and occurrence of a crack in the groove bottom of the thin groove 60 can be suppressed.

In the case where the cap rubber layer 29 is arranged on the inner side Ri in the tire radial direction of the thin groove 60, and the base rubber layer 30 made of rubber having a lower 100% modulus is arranged on the inner side Ri in the tire radial direction with respect to the cap rubber layer 29 in the embodiment, the main body rib 421 and the sacrifice rib 422 can be formed by the cap rubber layer 29 having a higher 100% modulus than the base rubber layer 30. Accordingly, the rigidity of the main body rib 421 and the sacrifice rib 422 can be secured. Moreover, due to the base rubber layer 30 having a relatively low 100% modulus arranged on the inner side Ri in the tire radial direction of the cap rubber layer 29, strains that intensively occur in the groove bottom of the thin groove 60 can be alleviated and occurrence of a crack in the groove bottom of the thin groove 60 can be suppressed.

In the embodiment, the gap G formed by the sacrifice rib 422 and the main body rib 421 is set to be smaller than the depth Ds of the sipe 65, and a bottom of the sipe 65 is covered by the sacrifice rib 422 when seen from the outer side Wo in the tire axial direction, which can suppress occurrence of a crack at the bottom of the sipe 65 due to a scratch from the side.

### EXAMPLE

In the pneumatic tire for heavy load shown in FIG. 1, evaluation was performed for examples and comparative examples under conditions where the tire size was set to 295/75R22.5, the air pressure was set to 760 kPa, the use rim was set to 22.5×8.25, and the load was set to 27.5 kN. The basic structure of respective tires in examples and comparative examples is as explained in the above embodiment. Ground contact states in finite element models were simulated by setting respective specifications as shown in Table 1 below, and the ground contact pressure at the outer end in the tire axial direction of the main body rib 421 and the shear strain of a surface element placed between the sipes 65 adjacent to each other in the tire circumferential direction CD were calculated.

The calculated ground contact pressures were evaluated by indexes by setting Comparative Example 1 as 100. The smaller the index is, the lower the ground contact pressure is, and the more excellent irregular wear resistance is. The calculated shear strains were evaluated by indexes by setting the Comparative Example 1 as 100. The smaller the index is, the lower the shear strain is, and the more excellent crack resistance is.

TABLE 1

| | Comp. | Comp. | Comp. | Comp. | | | | | | | | | |
|---|---|---|---|---|---|---|---|---|---|---|---|---|---|
| | Ex. 1 | Ex. 2 | Ex. 3 | Ex. 4 | Ex. 1 | Ex. 2 | Ex. 3 | Ex. 4 | Ex. 5 | Ex. 6 | Ex. 7 | Ex. 8 | Ex. 9 |
| Depth of Shoulder | 13.9 | 13.9 | 13.9 | 13.9 | 13.9 | 13.9 | 13.9 | 13.9 | 13.9 | 13.9 | 13.9 | 13.9 | 13.9 |
| Main Groove Dm | | | | | | | | | | | | | |
| (mm) | | | | | | | | | | | | | |
| Depth of Thin | 14.6 | 17.4 | 16 | 16 | 15.3 | 16 | 16.7 | 16 | 16 | 15.3 | 16.7 | 15.3 | 16.7 |
| Groove Dg (mm) | | | | | | | | | | | | | |
| Depth of Sipe Ds | 8.8 | 10.4 | 6.4 | 12.8 | 9.2 | 9.6 | 10 | 8 | 11.2 | 7.6 | 11.7 | 10.7 | 8.3 |
| (mm) | | | | | | | | | | | | | |
| Dg/Dm | 1.05 | 1.25 | 1.15 | 1.15 | 1.10 | 1.15 | 1.20 | 1.15 | 1.15 | 1.10 | 1.20 | 1.10 | 1.20 |
| Ds/Dg | 0.60 | 0.60 | 0.40 | 0.80 | 0.60 | 0.80 | 0.60 | 0.50 | 0.70 | 0.50 | 0.70 | 0.70 | 0.50 |
| irregular wear | 100.0 | 98.1 | 100.7 | 97.2 | 99.5 | 99.1 | 98.6 | 99.7 | 98.4 | 99.8 | 97.9 | 98.9 | 99.2 |
| Resistance | | | | | | | | | | | | | |
| Sipe Crack | 100.0 | 108.2 | 102.2 | 110.6 | 102.3 | 104.7 | 106.4 | 101.6 | 106.4 | 100.9 | 107.8 | 104.5 | 103.7 |
| Resistance | | | | | | | | | | | | | |

Results are as shown in Table 1. In the examples 1 to 9, irregular wear resistance can be improved while suppressing deterioration of crack resistance as compared with comparative examples.

Various embodiments have been explained above and these embodiments are provided by way of example and are not intended to limit the scope of the invention. These novel embodiments can be implemented in other various manners, and various omissions, substitutes, and modifications may occur within a scope not departing from the spirit of the invention.

### REFERENCE SIGNS LIST

10: pneumatic tire
12: bead
14: sidewall
16: tread
20: carcass ply
22: bead core
24: inner liner
26: belt
27: belt carcass wedge shaped rubber
28: tread rubber
29: cap rubber layer
30: base rubber layer
32: sidewall rubber
32A: outer end in tire radial direction
33: bead filler
34: bead filler
36A: center main groove
36B: shoulder main groove
38: center rib
40: intermediate rib
42: shoulder rib
42a: tread surface
48: inclined surface
60: thin groove
421: main body rib
422: sacrifice rib

What is claimed is:

1. A pneumatic tire for heavy load comprising:
a tread rubber provided on a tread;
a belt layer including a plurality of belts provided on an inner side in a tire radial direction of the tread rubber;
three or more main grooves provided on a tread surface of the tread rubber and extending in a tire circumferential direction; and
a plurality of ribs formed by the main grooves on the tread surface,
wherein the three or more main grooves include a shoulder main groove provided on an outer side in a tire axial direction,
the plurality of ribs include a shoulder rib formed on the outer side in the tire axial direction of the shoulder main groove,
the shoulder rib includes a thin groove extending in the tire circumferential direction on an inner side in the tire axial direction of a ground contact end, a main body rib formed on the inner side in the tire axial direction of the thin groove, a sacrifice rib formed on the outer side in the tire axial direction of the thin groove, and sipes provided in the main body rib and opening to the thin groove, and
a depth Dg of the thin groove, a depth Dm of the shoulder main groove, and a depth Ds of the sipe satisfy the following formulas (1) and (2).
1.10≤Dg/Dm≤1.20 formula (1)
0.5≤Ds/Dg≤0.7 formula (2)

2. The pneumatic tire for heavy load according to claim 1,
wherein the thin groove has a constant groove width in a depth direction.

3. The pneumatic tire for heavy load according to claim 1,
wherein the thin groove is provided on the outer side in the tire axial direction with respect to an outer end in the tire axial direction of the plurality of belts.

4. The pneumatic tire for heavy load according to claim 1,
wherein the tread rubber includes a cap rubber layer on which the tread surface is formed and a base rubber layer provided on the inner side in the tire radial direction of the cap rubber layer and having a lower 100% modulus than the cap rubber layer, and
the cap rubber layer and the base rubber layer are provided on the inner side in the tire radial direction of the thin groove.

5. The pneumatic tire for heavy load according to claim 1,
wherein a tread surface of the sacrifice rib is placed on the inner side in the tire radial direction with respect to a tread surface of the main body rib,
a gap is formed by the sacrifice rib and the main body rib, and
a dimension of the gap is smaller than the depth of the sipe.

6. The pneumatic tire for heavy load according to claim 5,
wherein the dimension of the gap is between 0.5 mm and 1.5 mm, inclusive.

7. The pneumatic tire for heavy load according to claim 1,
wherein a sipe width of the sipe gradually narrows from an inner end in the tire axial direction toward an open end that opens to the thin groove.
